(19) United States
(12) Patent Application Publication
(10) Pub. No.: US 2004/0151637 A1
(43) Pub. Date: Aug. 5, 2004

(54) Slide mount collection or storage device for biological specimen

(76) Inventor: Bradley Ferguson Davin, Seneca, SC (US)

Correspondence Address: John B. Hardaway, III, Nexsen Preut Jacobs & Pollard, LLC, Federal Station, P.O. Box 10107, Greenville, SC, 29603, US

(21) Appl. No.: 10/354,939

(22) Filed: Jan. 30, 2003

(51) Int. Cl. B01L 3/00

(52) U.S. Cl. 422/102

(57) ABSTRACT

The present invention related to a collection or storage device for a biological specimen. The device comprises a slide mount with a biological specimen collection material imbedded in the mount. A unique identification means is disposed on the device.

### TECHNICAL FIELD

The present invention relates to a collection slide for a biological specimen. The device comprises a rigid slide mount containing a biological specimen collection material. The device can be printed with a unique numbering system, which can be used for identification. An advantage of the present invention is that the use of the slide format will allow easy sampling transport, storage and automation in handling.

### BACKGROUND AND PRIOR ART

Sampling of body fluids, especially blood, is standard methodology for medical diagnostics. All states require newborns to be screened for diseases such as PKU. Dried blood has been found to be very useful for screening for diseases and for DNA analysis and has the advantage that a minimum amount of blood is required and the likelihood of broken shipping containers is not an issue. Screening for viral diseases such as HIV can be done in high volume at central laboratories with lower risk of exposure to technicians.

U.S. Pat. No. 6,007,104 and related U.S. Pat. No. 6,152,493 to Draper, disclose a combined medical device and form having a unitary substrate divided into a form portion and a device portion. Identification material, preferably identical and machine-readable, is present on both the form portion and the device portion. The Draper device comprises a one-piece substrate having a form portion and a device portion. Biographical data is included on a section on the form portion of the substrate. Form identification material is on the form portion while device identification material is on the device portion, such that one can match the two portions. A separation line divides the two portions, and thus separates the respective two identification materials.

The collection, shipment and storage of blood and other body fluids on porous “filter paper ” is now well developed. Reference is made to Ostrup, U.S. Pat. No. 5,460,057, and to U.S. Pat. Nos. 6,291,179; 6,294,203; and 6,447,804 and the plethora of references cited therein for a summary of the status of the art for blood sampling, especially for DNA analysis and to Putcha et al., U.S. Pat. No. 6,133,036 and references cited therein for the collection of other “clear” fluids. All are incorporated by reference herein. Representative commercial products are the Whatman FTA™ system and the Schleicher and Schuell ISO Code™ system.

Heretofore, collection has been based upon the multi-well principle long used for filtration and sample handling in laboratory settings. As automation is increased and laboratories operate 24 hours each day, there continues to be a need for higher throughput of samples using fewer technicians, and for totally automated storage and retrieval.

A related issue, in an era of increasing concern about bioterrorism, is security and safety of specimens being shipped from physician's offices and regional hospitals to large laboratories. An excellent review of shipping issues is Knudsen et al., Guidelines for the Shipment of Dried Blood Specimens, Infant Screening 16, (1) 1993 which summarizes the applicability of 42 CFR Part 72 to the handling of dried blood samples.

A need exists, therefore, for improved systems to ship, analyze and store dried body fluids in a safer, faster method with positive long-term identification of the source of the specimen.

### BRIEF DESCRIPTION OF THE INVENTION

An object of the present invention is to provide a rigid support for transport and handling of the biological specimen collection material such as paper.

Another object of the present invention is to provide protection to the biological specimen collection paper as a result of its being recessed in a cassette.

A further object of the invention is that it may be manufactured at a high rate using currently available equipment. In addition, the specimen samples may be shipped, analyzed and stored using available storage, shipping and handling sleeves and magazines already familiar to medical laboratories.

It is yet another object of the invention that the specimen sample holder may be permanently identified as by being serialized so as to prevent separation of the specimen from an indicium of source.

These and other objects of the invention may be attained by placing a specimen collection medium in a standard size 35 mm slide holder, the slide holder being permanently marked to prevent unintentional separation of the specimen from the indicium of source. The slide may be shipped in a sleeve, a linear magazine holding a plurality of specimens or a drum magazine.

The specimen holder, essentially a slide holder for a 35 mm projection film and may be pasteboard, plastic or equivalent rigid material into which a suitable filter paper has been placed. Each specimen slide is serialized by one or more of a die stamped or printed number or a bar code.

### BRIEF DESCRIPTION OF THE DRAWINGS

FIG. 1A shows the obverse and reverse of a specimen sample holder according to this invention.

FIG. 1B shows the location for the placement of indicia on the specimen holder.

FIG. 1C shows an exploded cross-section of the specimen holder.

FIGS. 1D and 1E show the inside surface of the two halves of the slide holder.

FIG. 2 is an exploded perspective of the internal Collection Paper prior to being cut to size.

### DETAILED DESCRIPTION OF THE INVENTION

The present invention relates to a biological specimen collection paper enclosed in a standard slide mount encasement. The collection paper is recessed within the slide which minimizes the potential for contamination during collection, shipment, analysis and storage.

A biological/DNA specimen collection material is encased in the slide mount casing. By such an arrangement, one can handle the slide mount without making contact with the collection material. The size being that of a standard film slide mount will allow the device to be handled in all equipment built to transport or store slide mounts.

To ease in application of the sample, the collection material can be printed with circles to aid in targeting the application of the sample as well as the retrieval of the sample,

The specimen collection paper may be any commercially available filter paper used for the collection, shipment, analysis and storage of biological fluids. Both untreated and treated papers may be used, depending upon the type of fluid to be tested, the type of test to be performed, and the expected time of storage. The papers are available from several sources and for purposes of this invention are most advantageously purchased in roll form. The rolls are punched so that they may be transported using sprockets in available film slide mounting equipment and mounted using such equipment using the same mounting procedures as in film slide handling. Representative is the Loersch™ slide mount system.

The frame portion of the obverse side at least may be marked to indicate a unique serial number for the specimen slide. The indicium may be stamped or printed in numeric or alpha numeric form. Additional information may be shown also relating to type of paper, source or distributor, date of manufacture, etc.

In the preferred embodiment, each specimen slide is imprinted with a barcode which becomes a serial number of that unique specimen slide. The barcode may be applied directly to the slide or printed on a label. One or more additional barcoded label strips attached to a release paper may be attached to the frame. The additional strips may be removed at the sampling location and placed on a permanent record at that location and/or removed at the processing laboratory for their records. One advantage of a barcode is that the information may be entered into a computer using an inexpensive wand-type scanner and forwarded to the analytical laboratory electronically. The specimen slides may be dried and shipped using conventional slide magazines as used in most slide projectors—either straight fed or carousel magazine style or pouch-type mailers described by Knudsen et al.

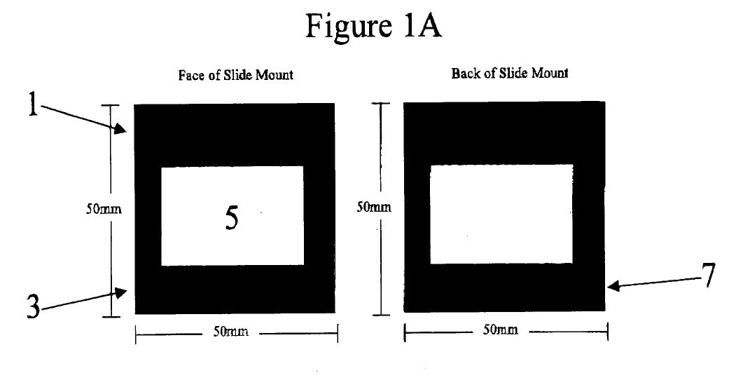

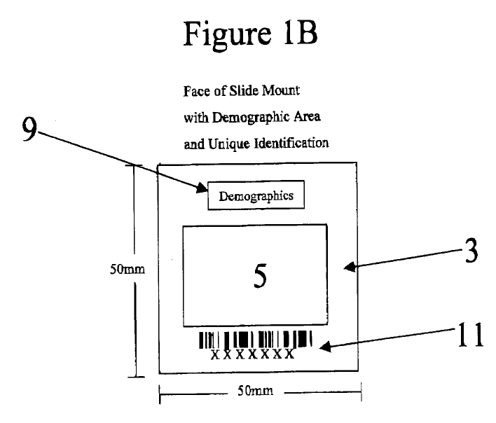

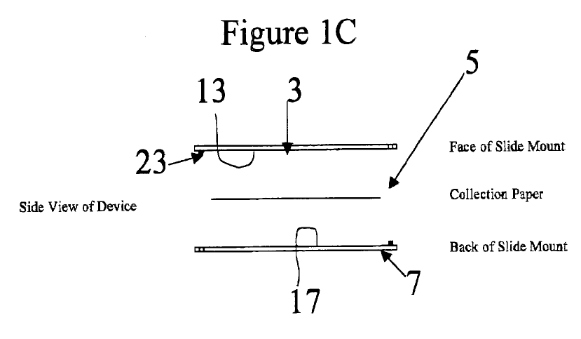

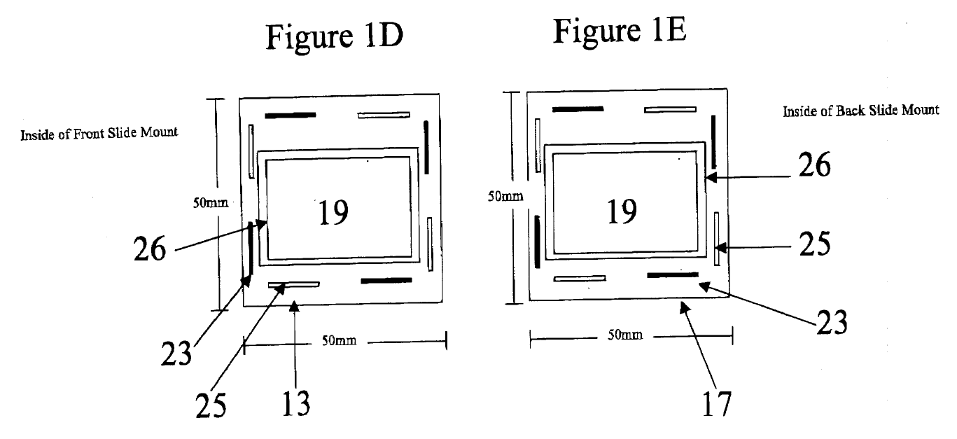

Referring to the drawings, FIG. 1A shows the slide mount 1 having an obverse frame face 3, a reverse frame face 7 and a window containing a specimen collection paper 5. FIG. 1B indicates an area of the obverse face 3 having a location 9 for entry of data and a barcode 11.

FIG. 1C shows an exploded view of a three-part specimen slide which is snapped together. The obverse face 3 has a back 13 and the reverse face 7 has a back 17. The specimen collection paper 5 is placed in a pocket 2-6 between the backs 13, 17 and the slide snapped together. As shown in FIGS. 1D and 1E, ridges 23 and grooves 25 match fact to face and snap together. This arrangement is most convenient with plastic slide mounts and has the advantage that the frame can be reused when there is no need to archive the specimen. Plastic mounts have the advantage that the mounts minimize strain on the collection paper, providing consistent dried blood densities for analysis. For this reason, the medium is held in a pocket 26 in the slide.

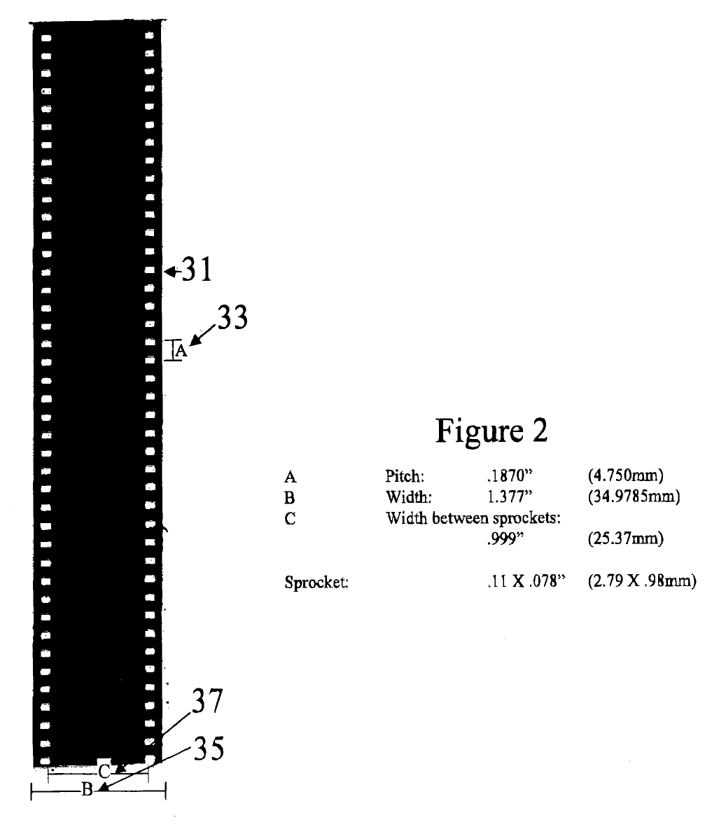

FIG. 2 shows a strip of specimen collection paper 31 that has sprocket holes 33 which have been punched at a pitch of approximately 4.750 mm. Standard width 35 for the paper is 34.97 mm and the width 37 between sprocket holds across the paper is 25.37 mm. This pattern is identical to that used in commercial 35 mm photographic film and allows assembly, shipping, processing and archiving to be done using available film handling equipment. The slide is suitable for two or three spots of approximately 9.5 mm diameter.

When the specimen is to be archived, instead of the arrangement shown in FIGS. 1C, 1D and 1E, the two sides of the slide may be bonded such as by using an adhesive.

Circles may be printed on the collection paper to provide a target for the sampling technician.

Once at the analytical laboratory, the specimen may be processed using any proprietary dried blood spot puncher, of which the BSD Technologies International Pty, of Queensland AU is preferred. The punch is then processed according to the protocol for the selected analysis.

Other embodiments of the present invention are not presented here which are obvious to those ordinarily skilled the art, now or during the term of any patent issuing form this patent specification, and thus, are within the spirit and scope of this present invention.

What is claimed:

1. A collection or storage device comprising;
a. a standard rigid slide mount;
b. a biological specimen collection material encased in said slide mount; and
c. a unique identification means.

2. A collection and storage device according to claim 1 wherein the slide mount is plastic.

3. A collection and storage device according to claim 1 wherein the slide mount is pasteboard.

4. A collection and storage device according to claim 1 wherein said specimen collection material is an untreated paper medium.

5. A collection and storage device according to claim 1 wherein said specimen collection material is treated to preserve the specimen.

6. A collection and storage device according to claim 1 wherein the said unique identification means is a stamped number.

7. A collection and storage device according to claim 1 wherein the said unique identification means is a printed alphanumeric identification.

8. A collection and storage device according to claim 1 wherein the said unique identification means is a barcode.

9. A collection and storage device according to claim 1 wherein the biological specimen collection material is mounted in said slide mount in an unstressed condition.
